(19) United States
(12) Patent Application Publication
(10) Pub. No.: US 2004/0249847 A1
(43) Pub. Date: Dec. 9, 2004

(54) System and method for identifying coherent objects with applications to bioinformatics and E-commerce

(75) Inventors: Haixun Wang, Tarrytown, NY (US); Wei Wang, Carrboro, NC (US); Jiong Yang, Urbana, IL (US); Philip Shi-Lung Yu, Chappaqua, NY (US)

Correspondence Address: Frank Chau, Esq., F. CHAU & ASSOCIATES, LLP, 1900 Hempstead Turnpike, East Meadow, NY, 11554, US

(73) Assignee: International Business Machines Corporation

(21) Appl. No.: 10/453,942

(22) Filed: Jun. 4, 2003

(51) Int. Cl. G06F 17/00

(52) U.S. Cl. 707/102

(57) ABSTRACT

The present invention provides system and method of clustering data from a data matrix. The method includes generating at least one initial cluster from the data matrix to form a submatrix and adding or removing a row or a column to reduce the average residue of the submatrix. The system includes means for generating at least one initial cluster from the data matrix to form a submatrix and means for adding or removing a row or a column to reduce the average residue of the submatrix.

### BACKGROUND OF THE INVENTION

1. Field of the Invention

The present invention relates to data mining, and, more particularly, to identifying coherent objects in a large database.

2. Description of the Related Art

Data mining in general is the search for hidden patterns that may exist in large databases. Information gathered from data mining techniques can be used by businesses, for example, to discover new trends and patterns of behavior that previously went unnoticed. Once they've uncovered this vital intelligence, it can be used in a predictive manner for a variety of applications, such as gaining insight on a customer's behavior.

Often one of the first steps in the data mining process is clustering. It identifies groups of related records that can be used as a starting point for exploring further relationships. Clustering supports the development of population segmentation models, such as demographic-based customer segmentation. Additional analyses using standard analytical and other data mining techniques can determine the characteristics of these segments with respect to some desired outcome. For example, the buying habits of multiple population segments might be compared to determine which segments to target for a new sales campaign.

Clustering has become an active research area in recent years. Many clustering algorithms have been proposed to efficiently cluster data in multidimensional space. An important advance in this area has been the introduction of subspace clustering. A subspace cluster consists of a set or subset of dimensions and a set or subset of points/vectors/objects such that these points/vectors/objects are close to each other in the subspace defined by the dimensions. This is particularly useful in clustering high dimensional data in which every dimension may not be relevant to a cluster. The conventional subspace clustering model takes into account only the physical distance between points/vectors when creating a subspace cluster. However, a strong correlation or coherence may exist among points/vectors/objects that are far apart.

For example, consider three sets of data vectors, each with five attributes: d₁=(1, 5, 23, 12, 20); d₂=(11, 15, 33, 22, 30); d₃=(111, 115 133, 122, 130). Under the conventional subspace clustering model, d₁, d₂, and d₃ may not be considered in the same cluster because the vectors are far apart. However, a closer examination of d₁, d₂, and d₃ reveal a strong coherence among the data vectors. In particular, given one vector in a set, the corresponding vector in the other two sets can be perfectly derived by shifting the vector by a certain offset or bias. In other words, the corresponding vectors show the similar tendencies, but with some bias. In the given example, vectors in d₁ differ from d₂ by a bias of 10 and from d₃ by a bias of 110. It should be noted that the order of the attributes is irrelevant, as a change in order would also show a strong coherence in the vectors.

Although the above example shows all five attributes coherent in each vector, in real world applications, coherent attributes may be buried in a much larger set of attributes. Identifying these coherent attributes can be a very challenging process. Coherence is common in many applications where each object in the application may naturally bear a certain degree of bias from other objects in the same application. Coherence is particularly relevant in instances where discovering patterns in large quantities of data is useful.

For example, coherence can be found in applications of DNA microarray analysis. Microarrays are one of the latest breakthroughs in experimental molecular biology. They provide a powerful tool by which the expression patterns of thousands of genes can be monitored simultaneously. Microarrays generate large quantities of data. Analysis of such data is becoming one of the major bottlenecks in the utilization of the technology. The gene expression data are organized as matrices, i.e., tables where rows represent genes, columns represent various samples such as tissues or experimental conditions, and numbers in each cell characterize the expression level of the particular gene in the particular sample. Investigations show that more often than not, several genes contribute to a disease. This has motivated researchers to identify a subset of genes whose expression levels rise and fall coherently under a subset of conditions, that is, they exhibit fluctuation of a similar shape when conditions change. Discovery of such clusters of genes is essential in revealing the significant connections in gene regulatory networks.

Coherence can also be found in applications of E-commerce. Recommendation systems and target marketing are important applications in the E-commerce area. In these applications, sets of customers/clients with similar behavior are identified to predict customer interest and make proper recommendations. For example, consider three viewers who rank four movies from 1 to 10, in which 1 is the lowest and 10 is the highest: (1, 2, 3, 5), (2, 3, 4, 6), and (3, 4, 5, 7). Although the individual rankings are different, the three viewers have coherent opinions on the four movies. Therefore, if the first two viewers rank a new movie as 2 and 3, respectively, then one can logically deduce from the previous data that the third viewer may rank the new movie as 4, assuming the same coherence is followed.

Recent research includes the bicluster model in the area of microarray analysis and the Pearson R correlation in the area of collaborative filtering. The bi-cluster model was proposed by Yizong Cheng and George Church in “Biclustering of Expression Data,” Proceedings of the 8^{th} Annual Conference on Intelligent Systems for Molecular Biology. Given a full specified data matrix (e.g., matrices of expression levels of genes under different conditions), a bicluster corresponds to a subset of rows (e.g., genes) and a subset of columns (e.g., experiment conditions) with a high similarity score. A greedy algorithm is also presented to discover a single bicluster. A major restriction of the bicluster model is that it requires the data matrix to be fully specified, that is, no unspecified entry is allowed. Additionally, the bicluster model does not provide any mechanism to control the potential overlap among multiple biclusters.

The general goal of collaborative filtering is to identify peer groups with similar interests/opinions in, for example, building an effective recommendation system. As such, collaborative filtering has been an important area in E-commerce. A discussion of current collaborative filtering techniques can be found in U.S. Pat. No. 4,870,579 entitled “System and Method for Projecting Subjective Reactions” and U.S. Pat. No. 4,996,642 entitled “System and Method for Recommending Items.” The Pearson R correlation is one of the representatives proposed by Upendra Shardanand and Pattie Maes in “Social Information Filtering: Algorithms for Automating ‘Word of Mouth,’” Proceedings of CHI'95, 210-217. The Pearson R correlation of two points/vectors/objects σ₁ and σ₂ is defined as

$$\frac{\sum ( {σ}_{1} - {σ}_{1}^{′} ) \sum ( {σ}_{2} - {σ}_{2}^{′} )}{\sqrt{\sum {( {σ}_{1} - {σ}_{1}^{′} )}^{2} \times \sum {( {σ}_{2} - {σ}_{2}^{′} )}^{2}}}$$

where σ₁′ and σ₂′ are the mean of all attribute values in σ₁ and σ₂, respectively. From this formula, we can see that the Pearson R correlation measures the correlation between two objects with respect to all attribute values. A large positive value indicates a strong positive correlation while a large negative value indicates a strong negative correlation. However, some strong coherence may exist only on a subset of dimensions. To illustrate, consider six movies in which the first three are action movie while the last three are family movies. Two viewers rank the movies as (8,7,9,2,2,3) and (2,1,3,8,8,9). The viewers' ranking can be grouped into two clusters: the first three movies in one cluster and the remaining three movies in another cluster. It is clear that the two viewers have consistent bias within each cluster. However, Pearson R value is small because there is not much global bias held by the ranks of the two viewers.

Therefore, a need exists for a system and method for measuring the coherence among objects while allowing the existence of individual biases. The system and method should allow for unspecified entries and overlapping clusters. The system and method should also discover strong coherence that may exist on only a subset of dimensions.

The present invention is directed to overcoming, or at least reducing the effects of, one or more of the problems set forth above.

### SUMMARY OF THE INVENTION

In one aspect of the present invention, a method of clustering data from a data matrix is provided. The method includes generating at least one initial cluster from the data matrix to form a submatrix and adding or removing a row or a column to reduce the average residue of the submatrix.

In another aspect of the present invention, a machine-readable medium having instructions stored thereon for execution by a processor to perform a method of clustering data from a data matrix is provided. The medium contains instructions for generating k initial clusters from the data matrix, determining best actions for every row and every column in each of the k clusters, determining an action order for the best actions, performing the best actions in the action order; and determining whether the quality of the clusters has improved.

In yet another aspect of the present invention, a system is provided for clustering data from a data matrix. The system includes means for generating at least one initial cluster from the data matrix to form a submatrix and means for adding or removing a row or a column to reduce the average residue of the submatrix.

These and other aspects, features and advantages of the present invention will become apparent from the following detailed description of exemplary embodiments, which is to be read in connection with the accompanying drawings.

### BRIEF DESCRIPTION OF THE DRAWINGS

The invention may be understood by reference to the following description taken in conjunction with the accompanying drawings, in which like reference numerals identify like elements, and in which:

FIG. 1 depicts a flowchart representation of one embodiment of the present invention;

FIG. 2 depicts, in further detail, a flowchart representation of generating k initial clusters, as described in FIG. 1;

FIG. 3 depicts, in further detail, a flowchart representation of generating a random cluster Cᵢ, as described in FIG. 2;

FIG. 4 depicts, in further detail, a flowchart representation of determining the best action for every row and column, as described in FIG. 1;

FIG. 5 depicts, in further detail, a flowchart representation of calculating the best action of a given row or column x, as described in FIG. 4;

FIG. 6 depicts, in further detail, a flowchart representation of calculating the gain G(x, Cᵢ) of the action A(x, Cᵢ), as described in FIG. 5.

FIGS. 7A and 7B depict, in further detail, a flowchart representation of calculating the residue of the cluster Cᵢ, as described in FIG. 6;

FIG. 8 depicts, in further detail, a flowchart representation of generating a weighted order O of n rows and m columns, as described in FIG. 1;

FIG. 9 depicts, in further detail, a flowchart representation of performing actions in a given order O, as described in FIG. 1;

FIG. 10 depicts, in further detail, a flowchart representation of determining whether the cluster quality improves, as described in FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

It is to be understood that the systems and methods described herein may be implemented in various forms of hardware, software, firmware, special purpose processors, or a combination thereof. In particular, the present invention is preferable implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachers herein, one of ordinary skill in the related art will be able to contemplate these and similar implementations of the present invention.

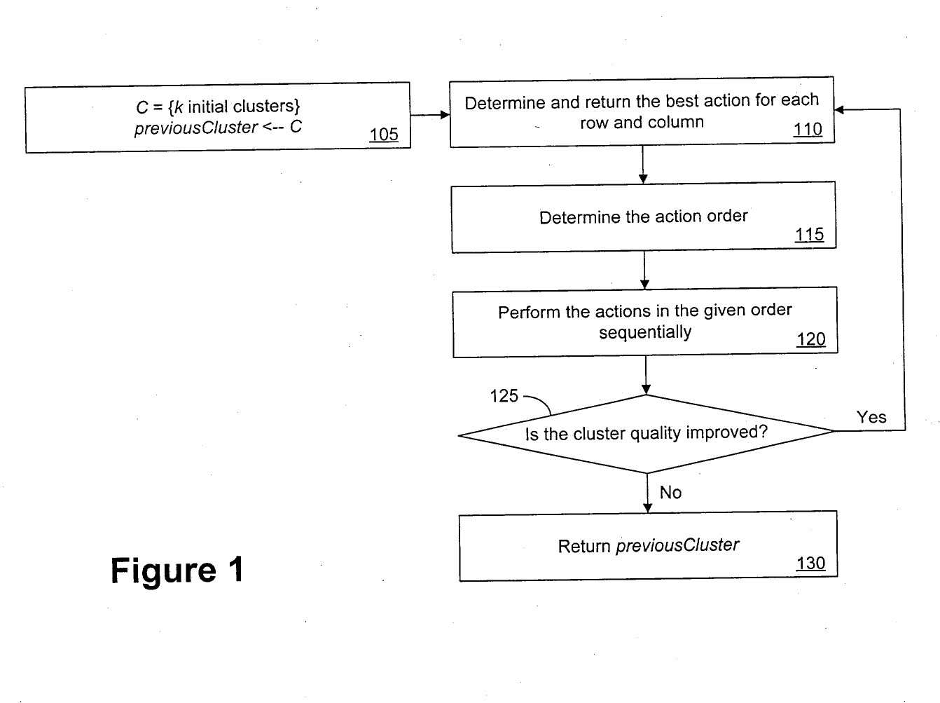

Referring now to the drawings, FIG. 1 illustrates an exemplary process of mining a delta-cluster. Conventional subspace clustering models generally capture points/vectors/objects (hereinafter referred to as “objects”) that are physically close to each other. The present invention, however, captures objects that have coherent dimensions/behaviors/attributes (hereinafter referred to as “attributes). The main objective of delta-clusters is to capture a set of objects and a set of attributes such that the objects exhibit strong coherence on the set of attributes despite the fact that the objects may be physically far apart. In other words, the delta-cluster model captures objects that may bear a non-zero bias. Conventional subspace clustering models can be viewed as a cluster of objects with zero bias (i.e., the objects are physically close to each other).

Referring again to FIG. 1, a set of k initial clusters is generated and stored (at 105) in C. The variable previousCluster is initialized (at 105) with the value stored in C. In the present invention, C is used to store the current status of the k clusters, and previousCluster is used to store the best result obtained at a given point in the process. The number of clusters, k, may be user-defined. The process then enters a loop that begins by determining (at 110) the best action for each row and column. The term “action,” as used in the present disclosure, is defined in relation to a row or column in a cluster. Given a row or column x and a cluster Cᵢ, the action A(x, Cᵢ) is definite as the change of membership of x with respect to Cᵢ. If x is not included in Cᵢ, then A(x, Cᵢ) denotes the addition of x to Cᵢ. If x is included in Cᵢ, then A(x, Cᵢ) denotes the removal of x from Cᵢ. Because there are k clusters, k actions will be associated with each row or column, among which the best action is determined (at 110). A total of n+m actions will be returned (at 110)—one for each of the n rows and m columns. The action order to perform the n+m actions is determined (at 115). The actions are then performed (at 120) according to the order determined (at 115). A decision is made (at 125) to determine whether quality of clustering is improving. If so, the process continues to another iteration, looping back to determining (at 110) the best action for each row and column. If not, the clustering store in previousCluster is returned (at 130) and the process terminates.

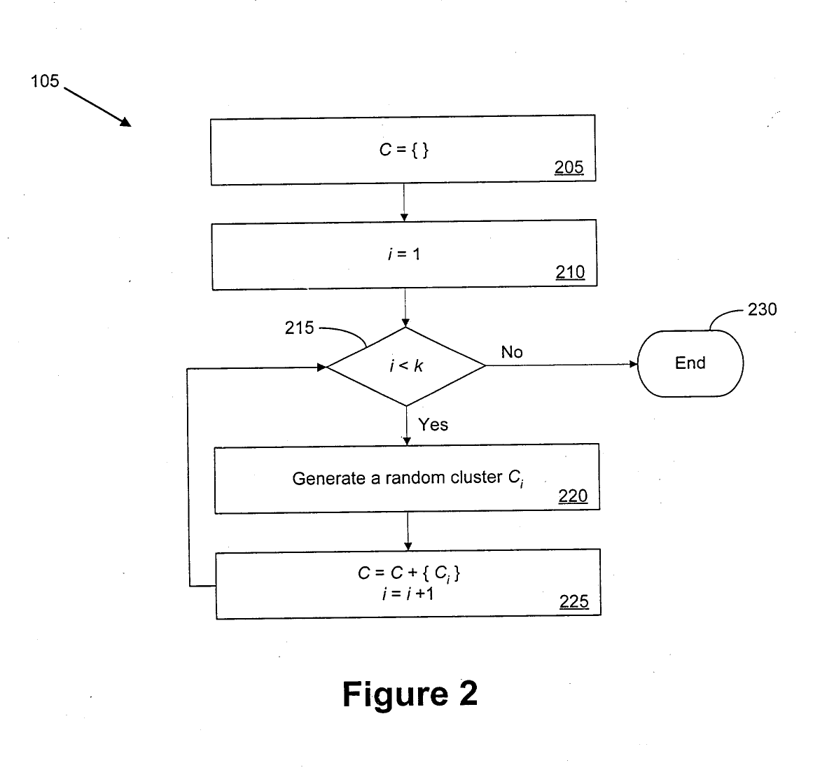

Referring now to FIG. 2, an exemplary embodiment of the process for generating (at 105 of FIG. 1) k initial clusters is shown. The set C is initialized (at 205) as an empty set. A counter i is initialized (at 210). The process then enters (at 215) a loop of k iterations. During each of k iterations, a random cluster Cᵢ is generated (at 220) and stored (at 225) in C. The counter i is increased (at 225) by 1. The loop repeats for k iterations until it terminates (at 230).

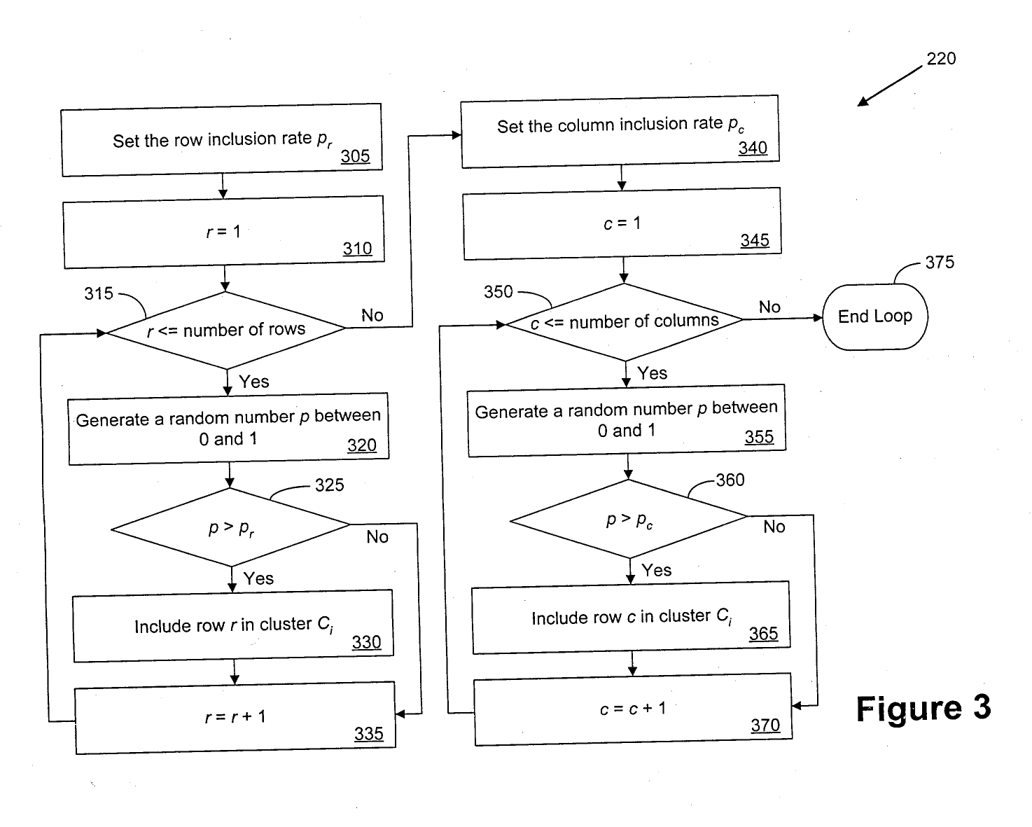

Referring now to FIG. 3, an exemplary embodiment of the process for generating (at 220 of FIG. 2) a random cluster Cᵢ is illustrated. Data to be mined may be stored in a matrix (hereinafter referred to as a “data matrix.”). One dimension of the data matrix may represent objects and another dimension of the data matrix may represent attributes. A delta-cluster corresponds to a submatrix in the data matrix and can be represented by the set of involved rows and columns. The percentage of unspecified entries in each involved row or column is to be within a predefined threshold oᵣ (for each involved row) or o_{c} (for each involved column). The predefined thresholds or and o_{c} may be user-defined.

As shown in FIG. 3, a row inclusion rate pᵣ is set (at 305). The row inclusion rate pᵣ is the probability that a row will be included in a generated cluster and should be set to a value greater than the threshold or but smaller than 1. The row inclusion rate pᵣ may be user-defined. A row counter r is initialized (at 310) to 1. The process then enters (at 315) a loop for a number of iterations equal to the number of rows in the data matrix. A random number p between 0 and 1 is generated (at 320). A decision is then made (at 325) to determine whether the random number p is greater than the row inclusion rate pr. If so, the row r is included (at 330) in the cluster Cᵢ. If not, the row r is not included in the cluster Cᵢ. The row counter r is increased (at 335) by 1 before the process loops back to the step of determining (at 315) whether all the rows have been examined.

After all rows have been examined, a similar procedure is carried out on all columns c. A column inclusion rate p_{c} is set (at 340). The column inclusion rate p_{c} may be user-defined. The column inclusion rate p_{c} is the probability that a column will be included in a generated cluster and should be set to a value greater than the threshold o_{c} but smaller than 1. A column counter c is initialized (at 345) to 1. The process then enters (at 350) a loop for a number of iterations equal to the number of columns in the data matrix. A random number p between 0 and 1 is generated (at 355). A decision is then made (at 360) to determine whether the random number p is greater than the column inclusion rate p_{c}. If so, the column c is included (at 365) in the cluster Cᵢ. If not, the column c is not included in the cluster Cᵢ. The column counter c is increased (at 370) by 1 before the process loops back to the step of determining (at 315) whether all the columns have been examined. Once all the columns have been examined, the process terminates (at 375).

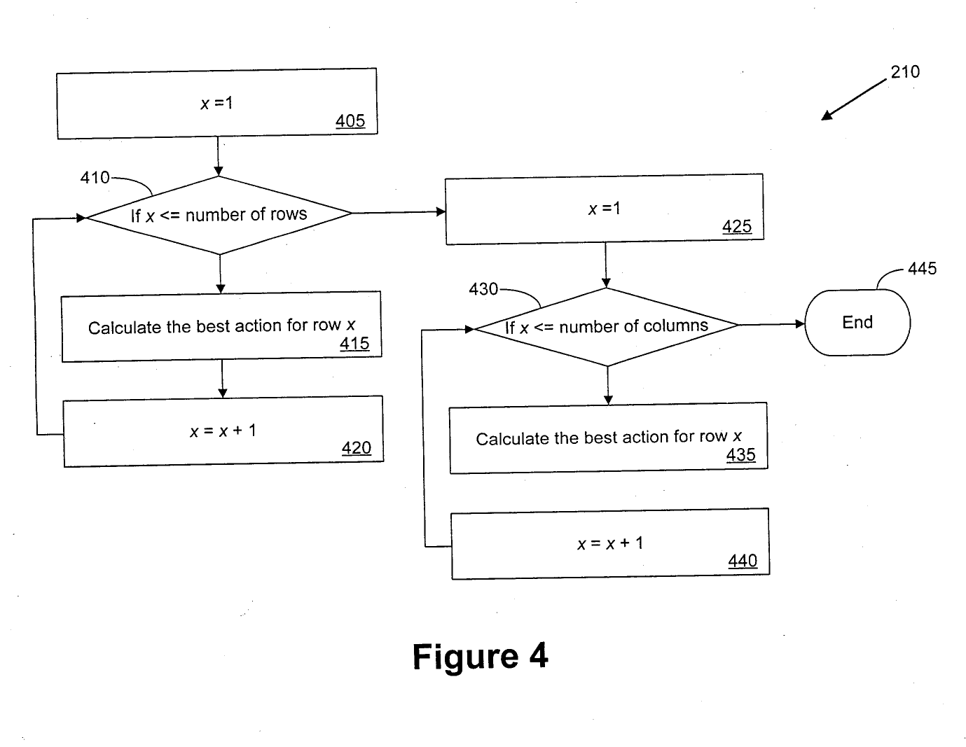

Referring now to FIG. 4, an exemplary process of determining (at 110 of FIG. 1) the best action for every row and column is illustrated. A generic counter x is initialized (at 405) to 1. The process then enters (at 410) a loop for a number of iterations equal to the number of rows in the data matrix. The best action for row x is calculated (at 415). The generic counter x is increased (at 420) by 1 before the process loops back to the step of determining (at 410) whether all the rows have been examined. After all rows have been examined, a similar procedure is carried out on all columns. The generic counter x is initialized (at 425) to 1. The process then enters (at 430) a loop for a number of iterations equal to the number of columns in the data matrix. The best action for column x is calculated (at 435). The generic counter x is increased (at 440) by 1 before the process loops back to the step of determining (at 430) whether all the columns have been examined. After all columns have been examined, the process terminates (at 445).

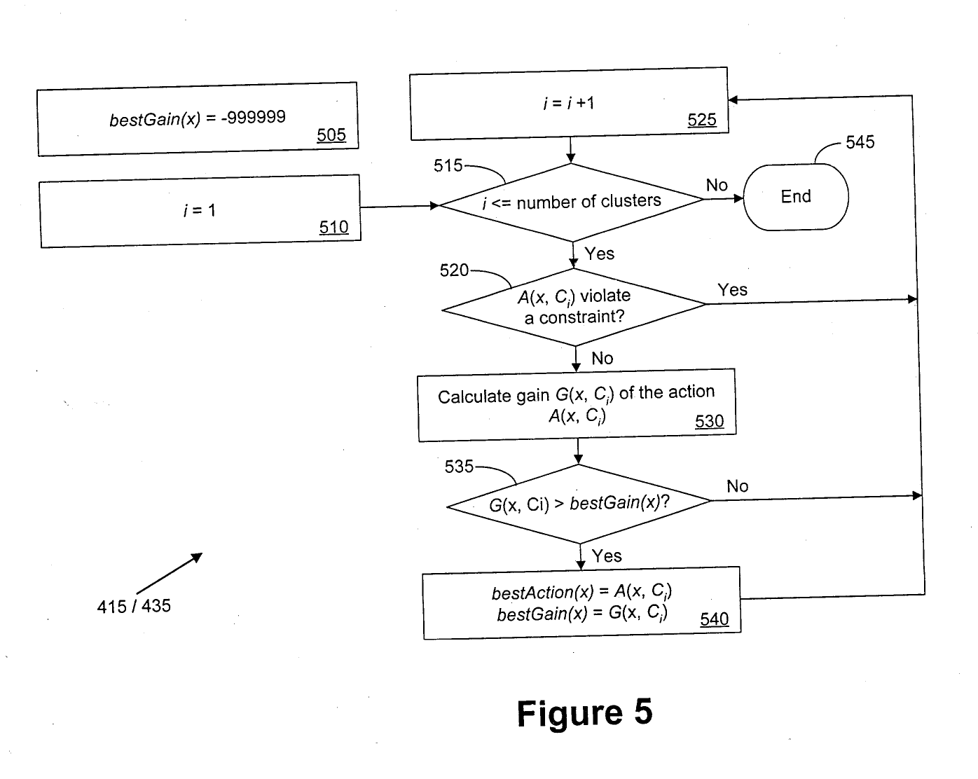

Referring now to FIG. 5, an exemplary process of calculating (at 415, 435 of FIG. 4) the best action of a given row or column, x, is shown. Because there are a total of k initial clusters, there are a total of k actions associated with a given row or column, x, each of which corresponds to the move of x with respect to each cluster. A variable bestGain(x) is initialized (at 505) preferably to a big negative number or negative infinity. A counter i is initialized to 1 before the process enters (at 515) a loop of k iterations. A cluster Cᵢ is examined during each iteration. A decision is made (at 520) to determine whether performing A(x, Cᵢ) will cause any constraint to be violated. A user is allowed to specify constraints (e.g., overlap among clusters, overall coverage of the clusters, volume of each cluster) to customize the result to suit the user's needs. If a constraint may be violated after performing the action A(x, Cᵢ), the action will be temporarily ignored by increasing (at 525) the counter i by 1 and looping back to the step of determining (at 515) whether k iterations have been performed. If no constraint is violated, the gain G(x, Cᵢ) of the action A(x, Cᵢ) is calculated (at 530). A decision is then made (at 535) to determine whether G(x, Cᵢ) is greater than bestGain(r). If so, the action A(x, Cᵢ) is stored (at 545) in bestAction(x) and its gain is stored in bestGain(r). The process ends (at 345) when the actions associated with x with respect to every cluster is examined.

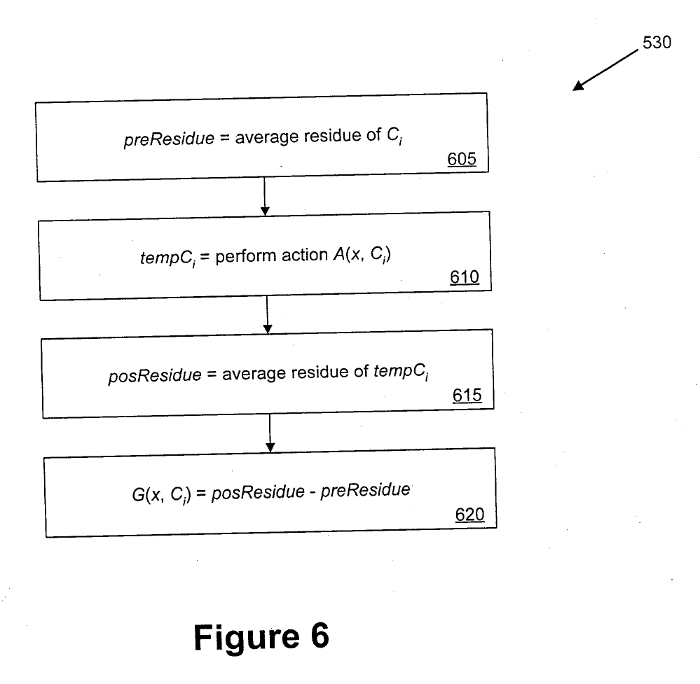

Referring now to FIG. 6, an exemplary process of calculating (at 530 of FIG. 5) the gain G(x, Cᵢ) of the action A(x, Cᵢ) is shown. The “gain” of an action is measured by the amount of residue of cluster Cᵢ as a result of performing the action A(x, Cᵢ). The term “residue” refers to the difference between the actual value of each entry in the data submatrix and the expected value based on the object bias within the cluster. The residue is a measurement of the degradation to the coherence of the delta-cluster that an entry brings. The residue of the cluster Cᵢ, before performing A(x, Cᵢ) is calculated and stored (at 605) in the variable preResidue. The resulting cluster after performing A(x, Cᵢ) is stored (at 610) in the variable temp Cᵢ, and its residue is computed and stored (at 615) in the variable posResidue. The gain of the action A(x, Cᵢ) is the difference between posResidue and preResidue and is stored (at 620) in G(x, Cᵢ).

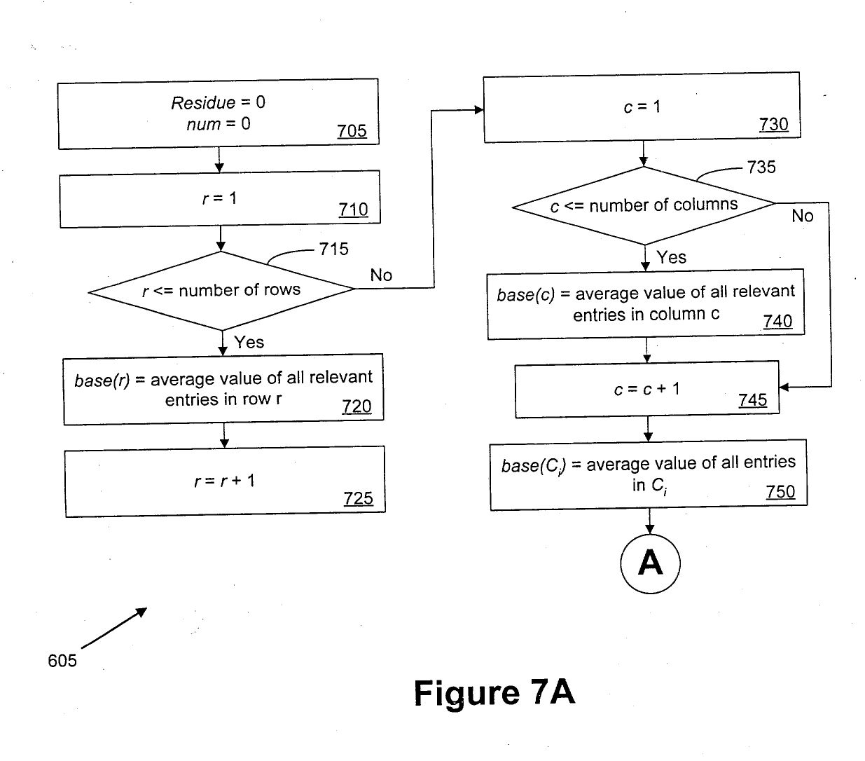

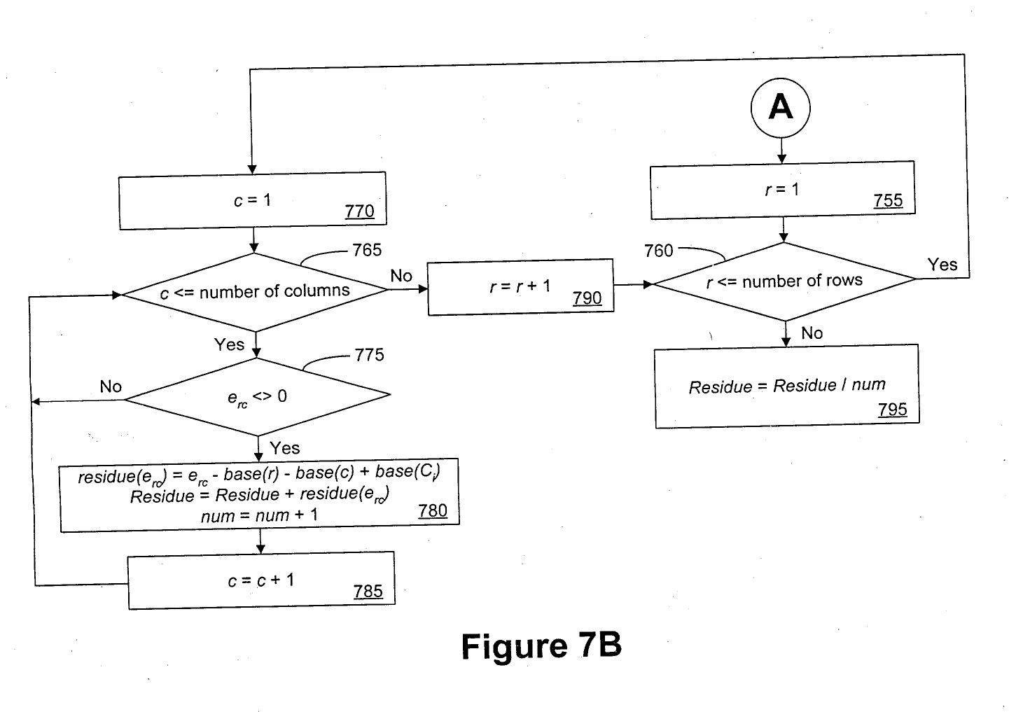

Referring now to FIGS. 7A and 7B, an exemplary process of calculating (at 605 of FIG. 6) the residue of the cluster Cᵢ is shown. The residue of a delta-cluster may be defined as a function of the residue of every entry. For example, the residue of a cluster Cᵢ may be defined as the average residue of each specified entry in the cluster. In this case, the smaller the residue, the stronger the coherence. An objection of the present invention is to find delta-clusters that minimize the residue. An entry in the cluster is represented by the variable e_{rc}. The residue of an entry residue(e_{rc}) (of row r and column c) is defined as 0 if e_{rc} is unspecified. Otherwise, residue(e_{rc})=e_{rc}−base(r)−base(c)+base(Cᵢ), in which base(r), base(c), and base(Cᵢ) are the base of row r in cluster Cᵢ, the base of column c in cluster Cᵢ, and the base of cluster Cᵢ, respectively. The base of row r in cluster Cᵢ, base(r), is defined as the average value of entries on row r in cluster Cᵢ. Similarly, the base of column c in cluster Cᵢ, base(c), is defined as the average value of entries on column c in cluster Cᵢ. The base of cluster Cᵢ, base(Cᵢ), is defined as the average value of entries in Cᵢ.

Referring again to FIG. 7A, two variables, Residue and num are initialized (at 705) to 0. The variable Residue stores the residue of cluster Cᵢ, and the variable num tracks the number of specified entries in Cᵢ. A row counter r is initialized (at 710) to 1. The process enters (at 715) a loop, where for each row r in cluster Cᵢ, the base, base(r), is calculated (at 720). The row counter c is incremented (at 725) by 1 until all rows have been examined. After computing all row bases, a column counter c is initialized (at 730) to 1 and the process enters (at 735) another loop, where for each column c in cluster Cᵢ, the base, base(c), is calculated (at 740). The column counter c is incremented (at 745) by 1 until all columns have been examined. After computing all column bases, the base of cluster Cᵢ, base(Cᵢ), is calculated (at 750).

Referring now to FIG. 7B, a continuation of the process of calculating (at 605 of FIG. 6) the residue of the cluster Cᵢ, as described in FIG. 7A, is shown. Continuing with the process as described in FIG. 7A, a row counter r is initialized (at 755) to 1. The process enters (at 760) a first loop, which cycles through the rows, and it also enters (at 765) a second loop after initializing (at 770) the column counter c. In other words, the process is now cycling through every entry in the cluster Cᵢ. For each entry in a given row r and column c, it is determined (at 775) whether the e_{rc} is specified (at 780). As previously mentioned, if e_{rc} is unspecified, it is defined as 0. For each specified entry e_{rc} (i.e., e_{rc} does not equal 0) in cluster Cᵢ, the residue is computed and stored (at 785) in residue(e_{rc}). The variable Residue maintains (at 785) the current aggregate residue of entries in cluster Cᵢ. The number of specified entries in cluster Cᵢ, num, is also incremented (at 785) by one. After all the columns have been examined in a given row, the row counter r is incremented (at 790) and another row is examined (at 760). After examining every specified entry in cluster Cᵢ, the average residue of Cᵢ is computed (at 795). The average residue of Cᵢ is calculated by dividing Residue by the number of specified entries, num.

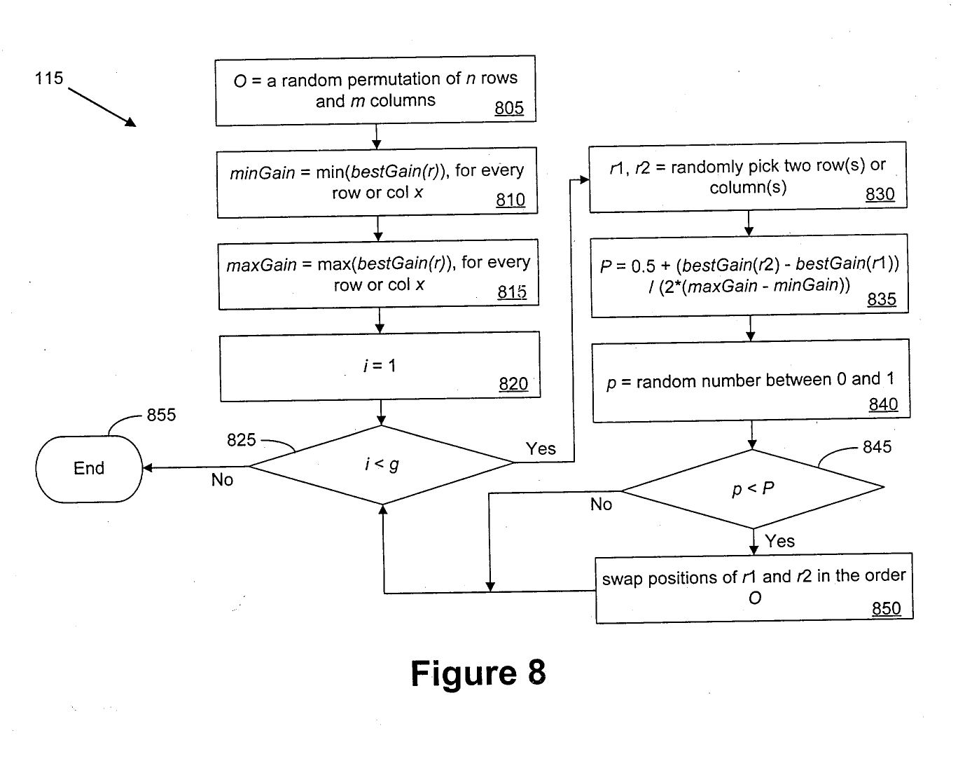

Referring now to FIG. 8, an exemplary process of generating (at 115 of FIG. 1) a weighted order O of n rows and m columns is shown. A random permutation of the n rows and m columns is stored (at 805) in O. For every row or column x, the minimum value of bestGain(x) is obtained and stored (at 810) in minGain. Similarly, the maximum value of bestGain(x) for every row or column x is obtained and stored (at 815) in maxGain. The pair (minGain, maxGain) defines the range of bestGain(x) of the n rows and m columns. A counter i is initialized (at 820) to 1. A loop of g iterations is entered (at 825). Preferably, the value of g is set in the order of 2(M+N) where M and N are the total number of columns and the total number of rows of the data matrix. Typically, M is greater than m and N is greater than n. During each of the g iterations, two rows or columns, r₁ and r₂, are randomly picked (at 830) in O. Assuming that r₁ is in front of r₂ in the order O, the probability P of swapping the positions of r₁ and r₂ in O is computed (at 835). In one embodiment,

$$P = 0.5 + \frac{bestGaiin ( {r}_{2} ) - bestGain ( {r}_{1} )}{2 ( maxGain - minGain )} .$$

The value of the probability is in proportion to the difference between the gains of best actions of r₂ and r₁. Actions with a higher gain will generally receive a higher probability to reside in front of the order O. A random number p between 0 and 1 is generated (at 840). A decision is made (at 845) to determine whether p is less than P. If so, the positions of r₁ and r₂ in the order O are swapped (at 850). Otherwise, no movement is made and the loop continues until g iterations are completed and the process is terminated (at 855).

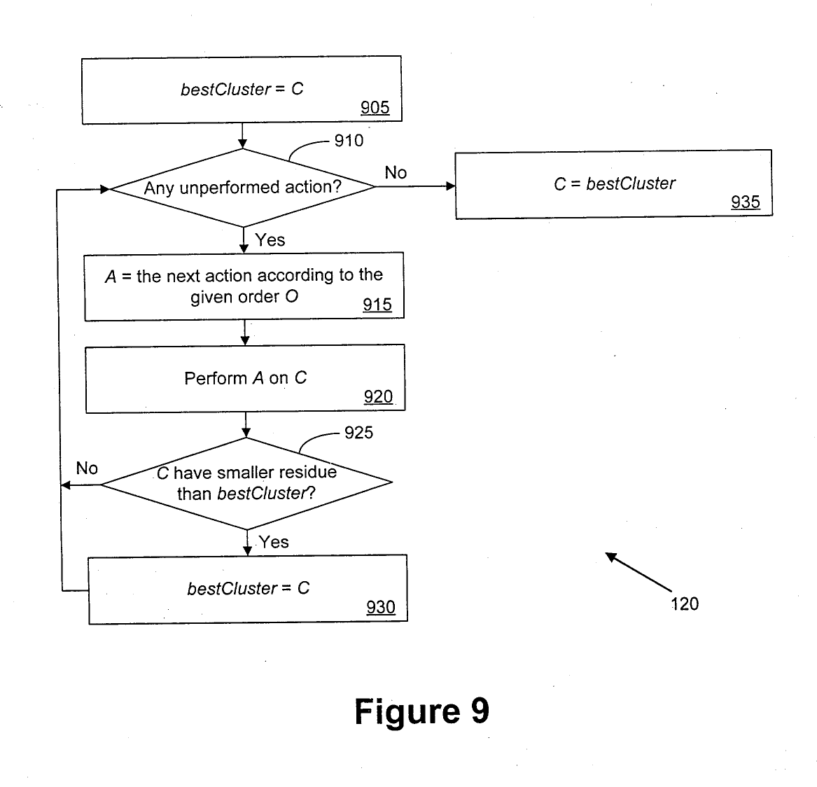

Referring now to FIG. 9, an exemplary process of performing (at 120 of FIG. 1) actions in a given order O. A variable bestCluster is initialized (at 905) to be equal to C. The variable bestCluster is used to keep track of the best result obtained at any stage during the course of performing actions according to the order O. A first decision is made (at 910) to determine whether there is some unperformed action. If so, the next action according to the order O is taken and stored (at 915) in the variable A. The variable A is performed (at 920). A second decision is made (at 925) to determine whether C has a smaller residue than bestCluster. If so, bestCluster is updated (at 930) before the process determines (at 910) whether there are any more unperformed actions. After all the actions have been performed, the best result obtained is copied (at 935) to C and serves as the starting point of any subsequent (potential) improvement.

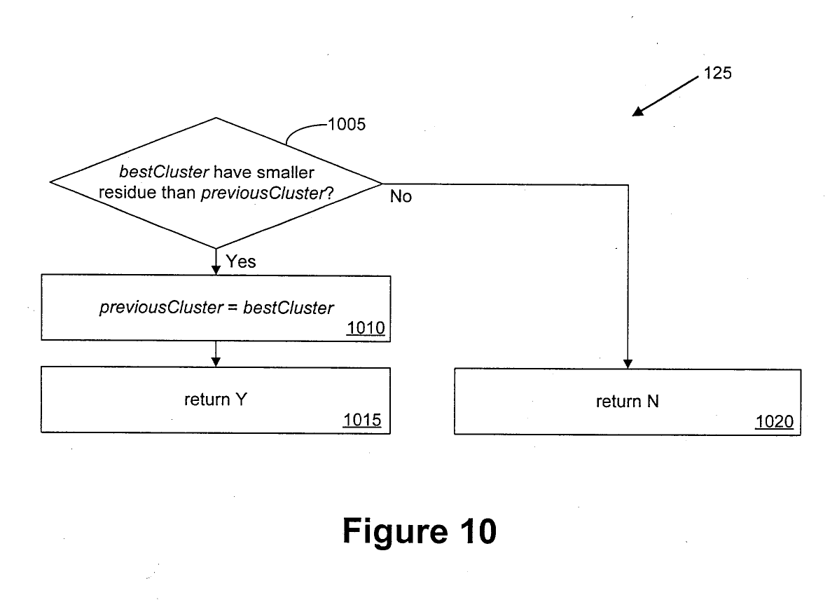

Referring now to FIG. 10, an exemplary process of determining (at 125 of FIG. 1) whether the cluster quality improves after performing a round of actions is shown. A decision is made (at 1005) to determine whether bestCluster has smaller residue than previousCluster. If so, the result stored in bestCluster is copied (at 1010) to previousCluster, and the positive answer Y is returned (at 1015). Otherwise, a negative answer N is returned (at 1020).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of clustering data from a data matrix, comprising:
generating at least one initial cluster from the data matrix; and
adding or removing a row or a column to reduce the average residue of the cluster.

2. The method of claim 1, wherein generating at least one initial cluster comprises generating k initial clusters.

3. The method of claim 1, wherein generating at least one initial cluster comprises randomly generating at least one initial cluster.

4. The method of claim 1, wherein generating at least one initial clusters comprises:
determining whether a row is included in the cluster; and
determining whether a column is included in the cluster.

5. The method of claim 4, wherein determining whether a row is included in the cluster comprises utilizing a row threshold, oᵣ, to determine the probability, pᵣ, that the row will be chosen to be included in the cluster, wherein oᵣ<pᵣ<1.

6. The method of claim 4, wherein determining whether a row is included in the cluster comprises utilizing a threshold, o_{c}, to determine the probability, pᵣ, that the row will be chosen to be included in the cluster, wherein o_{c}<p_{c}<1.

7. The method of claim 1, wherein adding or removing a rows or a column to reduce the average residue of the cluster comprises iteratively adding or removing a row or a column to reduce the average residue of the cluster.

8. The method of claim 1, wherein generating at least one initial cluster from the data matrix comprises specifying a constraint to limit overlap among clusters, wherein the overlap is measured as the percentage of entries that belong to multiple clusters.

9. The method of claim 1, wherein generating at least one initial cluster from the data matrix comprises specifying a constraint to control coverage of the clusters, wherein the coverage is defined as the percentage of entries that belong to some cluster.

10. The method of claim 1, wherein generating at least one initial cluster from the data matrix comprises specifying a constraint to control volume of each cluster, wherein the volume of a cluster is the number of specified entries in the cluster.

11. The method of claim 1, wherein adding or removing a row or a column to reduce the average residue of the cluster comprises:
determining a best action for the row or the column for a plurality of rows and columns;
determining an action order for the best actions of the plurality of rows and columns;
performing the best actions in the action order; and
determining whether the average residue of the cluster is reduced.

12. The method of claim 11, wherein determining a best action for a row or a column for a plurality of rows and columns comprises examining each row and each column sequentially.

13. The method of claim 11, wherein determining a best action for a row or a column for a plurality of rows and columns comprises evaluating whether the average residue of the cluster changes by adding or removing the row or the column.

14. The method of claim 11, wherein determining an action order for the best actions of the plurality of rows and columns comprises employing a weighted random order.

15. A machine-readable medium having instructions stored thereon for execution by a processor to perform a method of clustering data from a data matrix, comprising:
generating k initial clusters from the data matrix;
determining best actions for every row and every column in each of the k clusters;
determining an action order for the best actions;
performing the best actions in the action order; and
determining whether the quality of the clusters has improved.

16. The medium of claim 15, wherein determining best actions for every row and every column in each of the k clusters comprises measuring and evaluating the gain of the actions.

17. The medium of claim 15, wherein determining whether the quality of the clusters has improved comprises determining whether residue of the clusters has decreased.

18. A system of clustering data from a data matrix, comprising:
means for generating at least one initial cluster from the data matrix to form a submatrix; and
means for adding or removing a row or a column to reduce the average residue of the submatrix.
